(19) United States
(12) Patent Application Publication
(10) Pub. No.: US 2025/0066529 A1
(43) Pub. Date: Feb. 27, 2025

(54) Polyurethane Polymerized High Internal Phase Emulsions with Microporous Porosities

(71) Applicant: University of Cincinnati, Cincinnati, OH (US)

(72) Inventors: Neil Ayres, Loveland, OH (US); Emily Dalton, Cincinnati, OH (US)

(73) Assignee: University of Cincinnati, Cincinnati, OH (US)

(21) Appl. No.: 18/815,435

(22) Filed: Aug. 26, 2024

Related U.S. Application Data
(60) Provisional application No. 63/534,592, filed on Aug. 25, 2023.

(51) Int. Cl. C08G 18/08; C08G 18/67; C08G 18/73; C08G 18/75; C08G 18/76; C08G 18/87; C08J 9/28

(52) U.S. Cl. CPC C08G 18/0866; C08G 18/675; C08G 18/73; C08G 18/755; C08G 18/7614; C08G 18/87; C08J 9/283; C08G 2110/0066; C08J 2201/0524; C08J 2201/0544; C08J 2205/044; C08J 2375/04

(57) ABSTRACT

A method of making a polyurethane polymerized high internal phase emulsion (polyHIPE) is disclosed. The method involves preparing a polyurethane prepolymer and crosslinking the polyurethane prepolymer using a thiol-alkene Michael addition, producing a polyurethane polymerized high internal phase emulsion. In one embodiment, the polyurethane prepolymer is prepared by reacting diisocyanate and trimethylolpropaneallylether (TMPAE).

### CROSS REFERENCE TO RELATED APPLICATIONS

This application claims priority to U.S. Provisional Application Ser. No. 63/534,592, filed Aug. 25, 2023, which application is hereby incorporated by reference in its entirety.

### FIELD OF THE INVENTION

This invention relates generally to methods of making polymerized high internal phase emulsions.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Porous polyurethanes (PUs) are used in a wide range of applications including in the automotive, aeronautic, and biomedical fields due to their excellent mechanical properties, durability, high flexibility, and biocompatibility. Although 70% of the global PU market is associated with PU foams, preparing PU foams with controlled porosity, pore size, and pore morphology is often difficult with commonly used methods such as gas blowing or particulate leaching.

Controlling the porous structure in PU elastomers is important to manipulate their mechanical properties, damping behavior, and biomedical performance. A method to prepare highly porous polymers with controlled pore morphology is using polymerized high internal phase emulsions (polyHIPEs), as described in FIG. 1.

High internal phase emulsions are defined as concentrated emulsions in which the volume fraction of the internal dispersed phase is over 74%, which corresponds to the maximum packing fraction of monodispersed spherical shape droplets. In polyHIPEs, the continuous phase contains monomers that are polymerized to form a network around the dispersed phase droplets, and a porous polymer material is subsequently obtained after the removal of the dispersed phase.

Despite the simplicity of the preparation, a broad range of porosities pore sizes, morphologies including open vs closed cell structures, and moduli can be easily accessed through varying the composition of the emulsion template. As a result, polyHIPEs have been proposed for use in a large number of applications including absorption, adsorption, separation, catalytic supports, and scaffolds for tissue engineering.

Porous PUs synthesized using the polyHIPE technique have achieved much less attention than traditional gas-blown or porogen prepared foams, mainly due to the presence of millimeter-scale “craters” throughout the materials resulting from the formation of CO₂ bubbles formed from the side reaction between isocyanate-containing monomers and water in water-in-oil emulsion templates. Initially, the isocyanate-water reaction produces an unstable carbamic acid intermediate that immediately decomposes, generating an amine and liberating CO₂. For example, Silverstein and co-workers, synthesized highly interconnected macroporous polyurethane-urea using a water-in-oil HIPE template. The polyol-diisocyanate reaction occurred within the continuous phase, while urea functional groups formed from the water-diisocyanate reaction at the water-oil interface, generating CO₂ and producing millimeter scale large voids. One common method to eliminate the problem of CO₂ generation is to use an oil-in-oil emulsion template. For example, Zhao et al. reported the preparation of a hydrophobic, highly porous PU polyHIPE using non-aqueous HIPEs with dimethyl sulfoxide as the porogen. However, oil-in-oil emulsion templates require organic solvents that can result in increased environmental impact and increased costs for disposal of these solvents. Furthermore, it has been found that synthesizing polyHIPEs using step-growth polymerization may destabilize the HIPE template in some cases when using high polymerization temperatures or when by-products are formed in the polymerization reaction. As a result, the continuous phase is often cured using free radical polymerization as an alternative. Bismarck and coworkers made tough and robust crosslinked PU-containing polyHIPE by copolymerization of a polyurethane-diacrylate and styrene within the emulsion template.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

In one aspect of the present invention, a method of making a polyurethane polymerized high internal phase emulsion (polyHIPE) is disclosed. The method involves preparing a polyurethane prepolymer and crosslinking the polyurethane prepolymer using a thiol-alkene Michael addition, producing a polyurethane polymerized high internal phase emulsion. In one embodiment, the polyurethane prepolymer is prepared by reacting diisocyanate and trimethylolpropaneallylether (TMPAE). In another embodiment, the diisocyanate is hexamethylene diisocyanate. In one embodiment, the diisocyanate is isophorone diisocyanate. In another embodiment, the diisocyanate is toluene diisocyanate.

In one embodiment, the thiol-alkene Michael addition comprises mixing the polyurethane prepolymer with pentacrithritol tetrakis-3-mercaptopropionate (PETMP). In another embodiment, the polyurethane prepolymer is crosslinked using water as a dispersed phase. In one embodiment, the polyurethane prepolymer is crosslinked in less than 10 minutes.

In another aspect of the present invention, a polyurethane polyHIPE is disclosed that is produced using the method described above. In one embodiment, the polyHIPE has pores of a similar size and the majority of the pores are interconnected. In another embodiment, the polyHIPE has an average pore size from 5 to 10 μm. In one embodiment, the polyHIPE has an average density from 0.21 to 0.33 g/ml.

In another aspect of the present invention, a method of making a polyurethane polymerized high internal phase emulsion (polyHIPE) is disclosed. The method involves preparing a vinyl-functionalized polyurethane prepolymer and crosslinking the polyurethane prepolymer using a photoinitiated thiol-alkene reaction, producing a polyurethane polymerized high internal phase emulsion. In one embodiment, the polyurethane prepolymer is crosslinked using a water in oil emulsion template.

### BRIEF DESCRIPTION OF THE DRAWINGS

The objects and advantages of the present invention will be further appreciated in light of the following detailed descriptions and drawings in which:

FIG. 1 is a schematic showing the preparation of a water-in-oil polyHIPE.

FIG. 2A is a schematic showing a synthesis route for polyurethane prepolymer with vinyl functional groups.

FIG. 2B is a schematic showing various diisocyanate monomers.

FIG. 2C is a schematic showing a crosslinking reaction between vinyl-functionalized PU prepolymer and thiol-functionalized PETMP crosslinker to form the polyHIPE network.

FIG. 3A is an SEM image of a cross section of vacuum-dried HDI-PU polyHIPE. The scale bar in the images is 20 μm.

FIG. 3B is an SEM image of a cross section of air-dried HDI-PU polyHIPE. The scale bar in the images is 20 μm.

FIG. 3C is an SEM image of a cross section of freeze-dried HDI-PU polyHIPE. The scale bar in the images is 20 μm.

FIG. 3D is an SEM image of a cross section of freeze-dried IPDI-PU polyHIPE. The scale bar in the images is 20 μm.

FIG. 3E is an SEM image of a cross section of freeze-dried TDI-PU polyHIPE. The scale bar in the images is 20 μm.

FIG. 4A is a digital photograph of polyHIPE with 75% dispersed phase derived from HDI-PU during finger compression.

FIG. 4B is a digital photograph of polyHIPE with 75% dispersed phase derived from IPDI-PU during finger compression.

FIG. 4C is a digital photograph of polyHIPE with 75% dispersed phase derived from TDI-PU during finger compression.

FIG. 5A is a graph showing a storage modulus versus frequency plot comparing the G′ with respect to the type of diisocyanate of 70%-HDI-PU-PolyHIPE-(1:1) and 70%-IPDI-PUPolyHIPE-(1:1).

FIG. 5B is a graph showing a storage modulus versus frequency plot comparing the G′ with respect to the crosslinking ratio of (b) 70%-HDI-PU-PolyHIPE-(1:1) and 70%-HDI-PU-PolyHIPE-(2:1), (c) 70%-IPDI-PU-PolyHIPE-(1:1), and 70%-IPDI-PU-PolyHIPE-(2:1), with respect to the volume fraction of dispersed phase of (d) 70%-HDI-PU-PolyHIPE-(1:1), 60%-HDI-PU-PolyHIPE-(1:1), and 80%-HDI-PU-PolyHIPE-(1:1), (e) 70%-IPDI-PU-PolyHIPE-(1:1), 60%-IPDI-PU-PolyHIPE-(1:1), and 80%-IPDI-PU-PolyHIPE-(1:1).

FIG. 5C is a graph showing a storage modulus versus frequency plot comparing the G′ with respect to the crosslinking ratio of 70%-IPDI-PU-PolyHIPE-(1:1), and 70%-IPDI-PU-PolyHIPE-(2:1).

FIG. 5D is a graph showing a storage modulus versus frequency plot comparing the G′ with respect to the volume fraction of dispersed phase of 70%-HDI-PU-PolyHIPE-(1:1), 60%-HDI-PU-PolyHIPE-(1:1), and 80%-HDI-PU-PolyHIPE-(1:1).

FIG. 5E is a graph showing a storage modulus versus frequency plot comparing the G′ with respect to the volume fraction of dispersed phase of 70%-IPDI-PU-PolyHIPE-(1:1), 60%-IPDI-PU-PolyHIPE-(1:1), and 80%-IPDI-PU-PolyHIPE-(1:1).

FIG. 6A a graph showing compression stress vs strain curves of PU polyHIPEs comparing the young modulus with respect to the type of isocyanate showing complete behavior from 0 to 70% strain.

FIG. 6B is a graph showing compression stress vs strain curves of PU polyHIPEs comparing the young modulus with respect to the type of isocyanate with low-stress behavior from 1 to 12% strain.

### DEFINITIONS

As used herein, the term “about,” when referring to a value or to an amount of mass, weight, time, volume, pH, size, concentration, or percentage, is meant to encompass variations of, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods.

### DETAILED DESCRIPTION OF THE INVENTION

One or more specific embodiments of the present invention are described below. In an effort to provide a concise description of these embodiments, all features of an actual implementation may not necessarily be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One aspect of the present invention concerns polyurethane polymerized high internal phase emulsions (polyHIPEs) with microporous porosities. Polyurethanes with controlled microporosity are important because of their properties including a large surface area for applications in adsorption, low density which makes them extremely lightweight, and good thermal insulation and sound absorption for engineering and construction materials. The present invention provides a novel method of preparing polyurethane polymerized high internal phase emulsions materials with uniform and interconnected porosity through using a thiol-ene Michael addition cross linking reactions.

In one embodiment, the present invention uses water as the dispersed phase rather than an organic solvent (which is more expensive to use) and produces low mass density and high surface area polyurethane polyHIPEs with uniform and interconnected pores in a quick (less than 10 min) and easy fashion. The materials of the present invention are lightweight polyurethane materials with controllable materials properties. They will find particular utility in aeronautic, automotive, and other engineering industries.

In one embodiment, the present invention uses photoinitiated thiol-ene reactions between vinyl-functionalized polyurethane prepolymers and thiol-functionalized crosslinkers as an alternative route to synthesize PU polyHIPEs with small, uniform pore morphology using water in oil emulsion templates. PU prepolymers are used instead of isocyanate-containing monomers in the continuous phase of the emulsion to avoid the side reaction between isocyanate and water that results in large voids. The present invention presents a more sustainable approach to preparing porous polyurethane materials with tunable material properties for both industrial and biomedical applications using water-in-oil emulsion templating.

One method for preparing polyurethanes with microporosity is through an emulsion templating method. However, most emulsion templates rely on a water-in-oil emulsion, where the dispersed water phase can react with isocyanates in the monomers for the polyurethane, leading to the formation of CO₂ gas and resulting formation of large (mm-sized) pores. An alternative is to use oil-in-oil emulsions, but this can result in using large quantities of organic solvents and the consequent economic and environmental costs in disposing these. The present invention uses a novel chemistry where pre-formed polyurethanes are crossed using a thiol-alkene Michael addition reaction rather than an in situ polymerization, thereby avoiding the use of isocyanates. This results in the formation of polyHIPEs with uniform and interconnected pores. The materials properties of the polyHIPEs are dictated by the observed total porosity of the materials and the polymer chemistry of the polyurethanes.

As shown in the examples below, polyurethane polyHIPEs with small, uniform pore morphologies were successfully synthesized using thiol-ene reactions within water in oil HIPE templates. The polyHIPEs synthesize used PU prepolymers instead of isocyanate monomers in the emulsion to avoid the reaction between isocyanate and water that leads to the formation of CO₂-induced large voids. The polyHIPEs exhibited highly interconnected open-cell structures with pore sizes ranging from 5 to 10 μm and densities ranging from 0.21 to 0.33 g/ml. The material properties of the PU polyHIPE are significantly affected by the type of diisocyanate used in the PU synthesis. The PU polyHIPEs derived from flexible HDI-PUs had low storage moduli and Young's moduli compared to stiff IPDI-PU based polyHIPEs. However, TDI-PU polyHIPEs were brittle and chalky in nature, and full characterization of their material properties was not possible in some instances. The stoichiometric ratio of thiol crosslinker and vinyl-PU controls the storage moduli of relatively soft HDI-PU polyHIPEs but has no considerable effect on the stiffer IPDI-PU based polyHIPEs. As shown herein, the present invention demonstrates a viable and sustainable route to synthesize porous polyurethanes that can be applied to biomedical, aeronautic, and automotive manufacturing fields.

### EXAMPLES

### Materials

Hexamethylene diisocyanate (HDI, >99%, Sigma Aldrich), isophorone diisocyanate (IPDI, >98% Sigma Aldrich), and toluene diisocyanate (TDI, >98% Sigma Aldrich), trimethylolpropaneallylether (TMPAE, >98% Sigma Aldrich), and dibutyltin dilaurate (DBTDL, Sigma Aldrich) were used as received. The surfactant in the emulsions was Span80 (Sigma Aldrich) and the photo-initiator 2,2-dimethoxy-2-phenylacetophenone (DMPA, Sigma Aldrich). Pentacrithritol tetrakis-3-mercaptopropionate (PETMP, >99% Sigma Aldrich) was used as the tetrathiol crosslinker. Toluene (Sigma Aldrich) and dichloromethane (DCM, Sigma Aldrich) were used as the solvent in the continuous phase and Sodium chloride (NaCl, Oakwood chemical) was used as the salt in the aqueous dispersed phase. The chemicals were used as received.

### Synthesis of Polyurethane Prepolymer

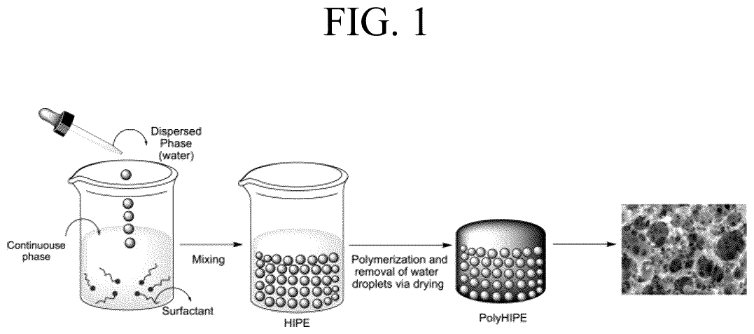

Referring to FIG. 1, Polyurethane (PU) prepolymer was prepared by reacting the diisocyanate and TMPAE in a 1:1 mole ratio. The compositions of each PU prepolymer are given in Table 1. In a typical reaction, the required amounts of diisocyanate, TMPAE, and toluene (twice the volume of the monomers) were measured in a flame-dried round bottom flask and 1 drop of DBTDL catalyst was added to the solution under stirring. The polymerization was performed under a moisture-free N2 atmosphere at 65° C. for 30 min to synthesize HDI based PU and 60 min to synthesize both IPDI and TDI based PU. The resulting polymer was purified by removing residual monomers and catalysts via solvent precipitation where the polymer was first dissolved in DCM and then precipitated in cold hexane. The precipitated product was isolated by filtration. The precipitation steps were repeated three times and finally, the polymer was dried in a vacuum oven at room temperature for 48 h. The HDI-TMPAE-PU was a transparent rubbery solid while both IPDI-TMPAE-PU and TDI-TMPAE-PU were white solid powder. The yields of each PU prepolymer are given in Table 1.

TABLE 1
Monomer compositions used to make Polyurethane prepolymers

| | Moles of | Mass of | Moles | Mass | |
|---|---|---|---|---|---|
| | diisocyanate | diisocyanate | of diol | of diol | Yield |
| PU-prepolymer | (mol) | (g) | (mol) | (g) | (%) |
| HDI-TMPAE-PU | 0.02 | 2.9 | 0.02 | 3 | 91% |
| IPDI-TMPAE-PU | 0.03 | 6.5 | 0.03 | 5.1 | 78% |
| TDI-TMPAE-PU | 0.03 | 5.3 | 0.03 | 5.1 | 79% |

### Polyurethane polyHIPE Synthesis

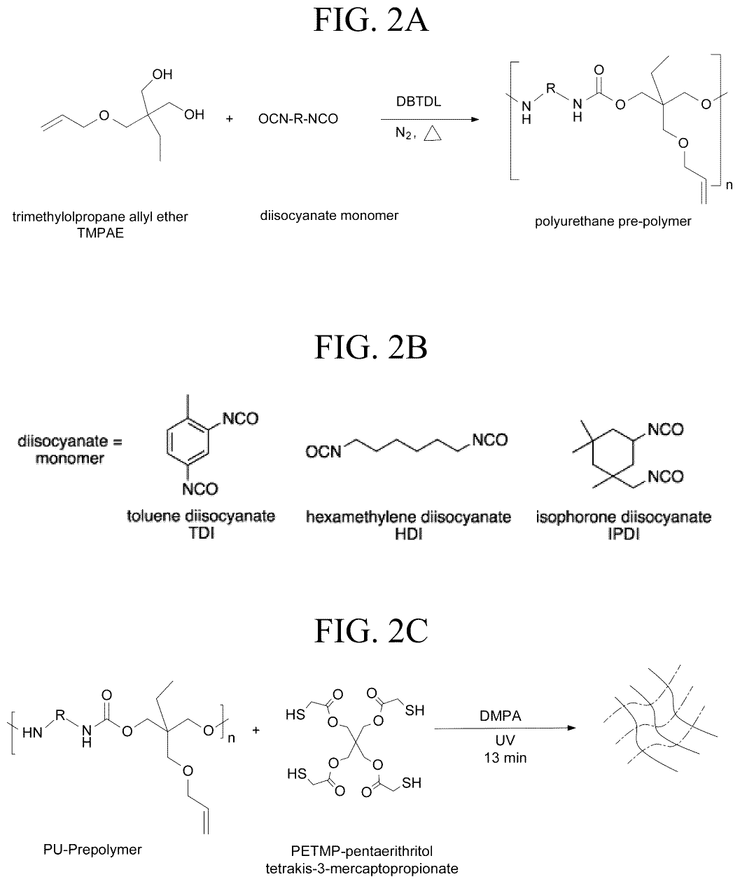

Referring to FIG. 2A, polyurethane polyHIPEs were prepared in the following manner. PU polyHIPEs with a 1:1 thiol to ene functional group mole ratio were synthesized using the water-in-oil HIPE formulations shown in Table 2.

TABLE 2
Formulations of the three PU polyHIPEs

| | | |
|---|---|---|
| HDI-PU | IPDI-PU | TDI-PU |
| polyHIPE | polyHIPE | polyHIPE |

Continuous phase, wt %

| | | | |
|---|---|---|---|
| PU prepolymer | 2.51 | 2.59 | 2.52 |
| PETMP thiol | 0.89 | 0.8 | 0.88 |
| crosslinker | | | |
| DMPA | 0.17 | 0.17 | 0.17 |
| photoinitiator | | | |
| DCM | 14.27 | 14.4 | 14.31 |
| Toluene | 7.16 | 7.2 | 7.15 |

Dispersed phase wt %

| | | | |
|---|---|---|---|
| 1.5% wt/vol | 75 | 74.85 | 75 |
| NaCl (aq) | | | |
| Span 80 | 0.56 | 0.64 | 0.56 |
| surfactant | | | |

First, the required amount of vinyl-PU prepolymer was added to a glass vial and dissolved in a mixture of toluene and DCM (twice the combined mass of PU prepolymer and thiol crosslinker). The PETMP tetrathiol crosslinker, span 80 (10 wt % with respect to the weight of the total continuous phase) and DMPA (5 wt % with respect to PU prepolymer and thiol crosslinker) were added and the mixture vortexed until it became homogeneous. A 1.5% wt/vol NaCl solution in Milli-Q water was prepared as the dispersed phase and added dropwise into the continuous phase. The two phases were vortexed until a uniform emulsion formed without any phase separation. The emulsion was then poured into a 40 mm×40 mm×4 mm square mold and irradiated with UV light (λₘₐₓ=365 nm) for 13 min. The resulting polyHIPE was removed from the mold and immersed in methanol (150 ml) for 24 h and then in water (500 ml) for another 24 h to remove the toluene from the polyHIPE. The obtained polyHIPE was freeze-dried for 8 h.

### Methods

PU prepolymers were characterized using ¹H and ¹³C{¹H} NMR spectroscopy with a Bruker Ultrashield instrument at 400 MHz and 200 MHz respectively with CDCl₃ as the solvent. The NMR spectra were analyzed using MestReNova software. Gel permeation chromatography (GPC) was performed using a TOSOH-ECOSECHLS-8320 series HPLC with three TSKgel H_{XL} columns with THE as the mobile phase at a flow rate of 1.0 ml/min at 40° C., and refractometer detector with Tungsten lamp as the light source, calibrated against polystyrene standards (630-92000 Da) and EcosSEC software to analyze data. Fourier-transform infrared (FTIR) spectra were obtained using Nicolet 6700 spectrometer and spectra were evaluated with OMNIC32 software. Pore morphology of PU polyHIPEs cross sections were characterized using a scanning electron microscope (Low-Vac) (FEI XL-30) equipped with an EDAX detector after polyHIPE samples were sputter-coated with gold for 10 s. Mechanical properties of PU polyHIPEs were characterized using PerkinElmer dynamic mechanical analyzer (DMA-8000) and data were analyzed using Pyris software. Rectangular shape polyHIPEs were prepared with dimensions of ˜2 mm thick, ˜5 mm width, and ˜7 mm length. The samples were subjected to a tension of 0.01 mm strain with a frequency sweep of 1-100 Hz. Uniaxial compression tests were performed on cylindrical polyHIPE samples with a diameter ˜20 mm and thickness of ˜2 mm until a stress of 160 KPa was reached using a Rheometer (Model HR-2, TA Instruments) with 20 mm diameter parallel plates at a rate of 0.5 mm min 1. The porosities and bulk densities of PU polyHIPEs were determined by an outside laboratory (Particle Technology Labs) using Mercury intrusion porosimetry (MIP). The porosity was calculated using the following equation: Porosity=Total Intruded Volume/Sample Bulk Volume

The bulk density was calculated using the following equation: Bulk Density=Sample Mass/Sample Bulk Volume

### Results

Three types of polyurethane prepolymers were synthesized using the commercially available diisocyanates, HDI, IPDI, and TDI, and TMPAE as the diol to install double bonds as pendant groups in the polymer chains that can undergo thiol-ene crosslinking reaction in the templated polymerization (FIGS. 2A and 2B).

The three PU polymers were prepared in high yields in the presence of a catalyst. The number average molecular weights (Mₙ) and the dispersity of the PU prepolymers are shown in Table 3.

TABLE 3
Number-average molecular weight and dispersity
of synthesized polyurethane prepolymers

| PU-prepolymer | Mₙ (g mol⁻¹) | Dispersity (Ð) |
|---|---|---|
| HDI-TMPAE-PU | 24000 | 1.3 |
| IPDI-TMPAE-PU | 7000 | 1.8 |
| TDI-TMPAE-PU | 13600 | 1.4 |

Mₙ = number average molecular weight

### Number Average Molecular Weight

The PU prepolymers were characterized using FTIR spectroscopy. The spectra showed the presence of an N-H stretch around 3320 cm⁻¹, a CO stretch around 1690 cm⁻¹, and N-H bending around 1520 cm⁻¹, corresponding to the urethane group, confirming the synthesis of the polyurethane. Furthermore, the absence of a peak around 2250 cm⁻¹ corresponding to the CN stretch of the isocyanate indicates that there are no isocyanate functional groups in the PU that can lead to the side reaction with water in the emulsion template to form CO₂. The ¹H NMR and ¹³C NMR spectra of each PUs exhibited peaks according to the expected structure with peaks around 5.8-5.2 ppm in ¹H NMR due to vinyl protons from the TMPAE.

PU polyHIPEs were prepared using thiol-ene click reactions within water-in-oil emulsion templates. A commercially available surfactant was used in the emulsion template, span80, which has a HLB value of 4.3 and can stabilize water-in-oil emulsions. The continuous phase consisted of the vinyl-functionalized PU prepolymer and a tetrathiol crosslinker (PETMP) in a mixture of toluene and DCM. The HIPEs were stable with no phase separation over the duration of the observation and the continuous phase underwent the thiol-ene reaction when irradiated with UV light in the presence of the DMPA photoinitiator to form a crosslinked polymer network (FIG. 2C).

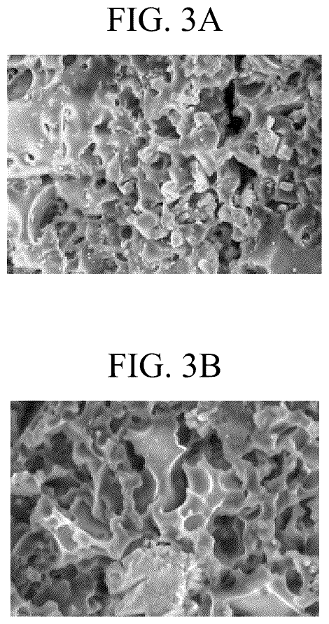

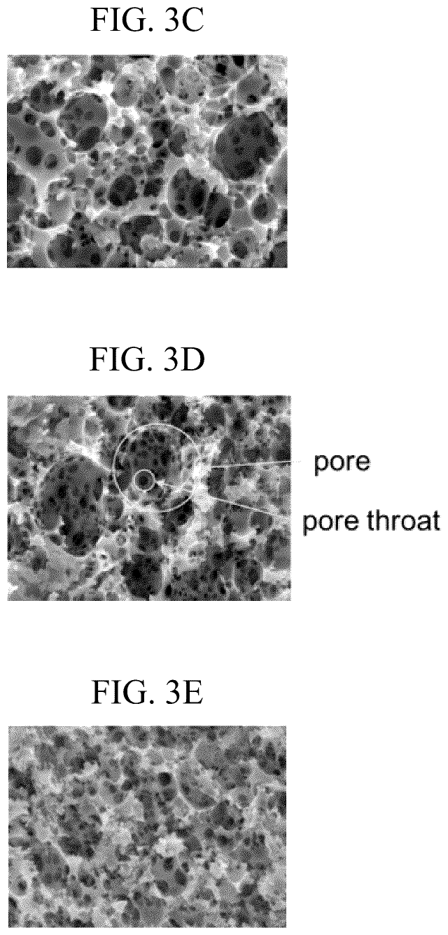

The use of PU prepolymers containing vinyl-functional groups with thiol functionalized crosslinkers eliminates the need for isocyanates in the water-in-oil polyHIPEs, avoiding the side reaction between water and isocyanate. Furthermore, the UV-initiated thiol-ene click reactions are rapid reactions (typically the polymerizations occurred in under 13 min) that do not require high temperatures which can destabilize the HIPE templates. Initially, the PU polyHIPEs were dried under vacuum at room temperature, but when this was done the obtained monoliths were transparent rather than the expected white solids. This is indicative of the polyHIPEs losing their porous structure. SEM images of the polyHIPEs were obtained after vacuum drying to determine if pore collapse was occurring, and SEM images of a polyHIPE prepared from HDI-TMPAE PU with 70% dispersed phase volume fraction after vacuum drying is shown FIG. 3A, where the pore morphology indeed appears to be collapsed. Pore collapse can occur due to the deformations of the polymer network when the solvents used in the emulsion template are removed under vacuum drying. Following this result, other drying methods were investigated, including air drying and freeze drying. Pore collapse was also observed in the SEM images for air-dried polyHIPE samples, as shown in FIG. 3B.

PolyHIPEs with highly interconnected open-cell pore morphologies were obtained for the freeze-dried polyHIPE samples. FIGS. 3C-3D show SEM images of freeze-dried PU polyHIPEs prepared with 75% dispersed phase volume fraction. In the freeze-drying process, the toluene in the samples was first extracted into methanol and then the methanol in the samples was extracted into water. The samples were then frozen at approximately −10° C. which is well below the glass transition temperature of the PUs. Therefore, the polymer matrix is hard at this temperature helping in preventing deformations in the polymer network. Analysis of the SEM images in FIGS. 3C-3E reveal that the pore sizes in the polyHIPEs range from 5 to 10 μm and the interconnecting pore throats are 0.2-2 μm. Overall, there appear to be more voids and fewer intact pore walls for the TDI-based PU polyHIPE due to the brittleness of the polymer network arising from the rigid aromatic groups in TDI. Significantly, millimeter-scale “craters” were not observed in the SEM images of the PU polyHIPEs as no CO₂ was formed in the polyHIPE synthesis because of the use of PU prepolymers, which eliminates the presence of isocyanate functional groups in the HIPE.

The measured porosities and bulk densities of the PU polyHIPEs are presented in Table 4.

TABLE 4
PolyHIPE properties

| | Volume of dispersed | | Bulk density |
|---|---|---|---|
| polyHIPE | phase in HIPE | Porosity | (g/ml) |
| HDI-PU-polyHIPE | 75% | 60% | 0.33 |
| IPDI-PU-polyHIPE | 75% | 70% | 0.31 |
| TDI-PU-polyHIPE | 75% | 77% | 0.21 |

Porosity and bulk density were determined using Mercury intrusion porosimetry.

The relatively soft HDI containing PU polyHIPE possesses a total porosity of 60%, which is lower than the dispersed phase volume of 75% used to prepare the polyHIPE. A slightly lower total porosity of 70% in the polyHIPE derived from IPDI-PU was calculated compared to the volume fraction of dispersed phase (75%) used in the emulsion template. These reduced calculated porosities in the polyHIPEs compared to the dispersed phase volume fraction in the emulsion templates indicate partial pore collapse due to the contraction of the materials that occurs during curing and/or drying. In contrast, a total porosity of 77% for the rigid TDI-PU polyHIPE was determined, indicating that it did not undergo the same extent of partial collapse as the more flexible polyHIPEs. Encouragingly, even though some pore collapse was determined from the porosity calculations, the SEM images of the materials (FIGS. 3C-3E) still show highly porous materials with no large, macroscopic, voids.

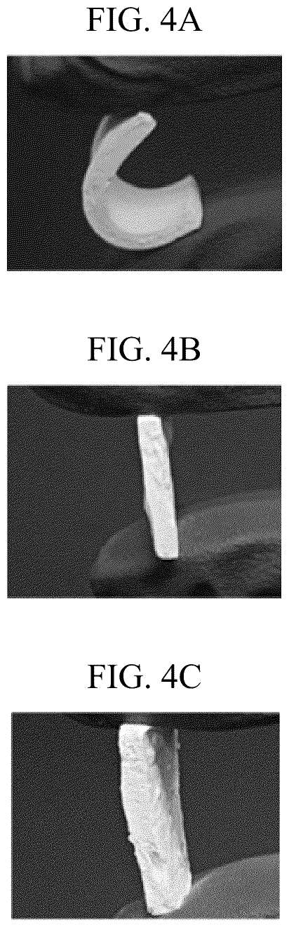

The polyHIPEs prepared from HDI-, IPDI-, and TDI-containing PUs are all white porous monoliths with similar pore morphologies and total porosity. However, they exhibited markedly different material properties. PolyHIPEs from HDI-based PUs were flexible and could bend without breaking due to the flexible nature of the HDI-PU polyHIPE, as shown in FIG. 4A.

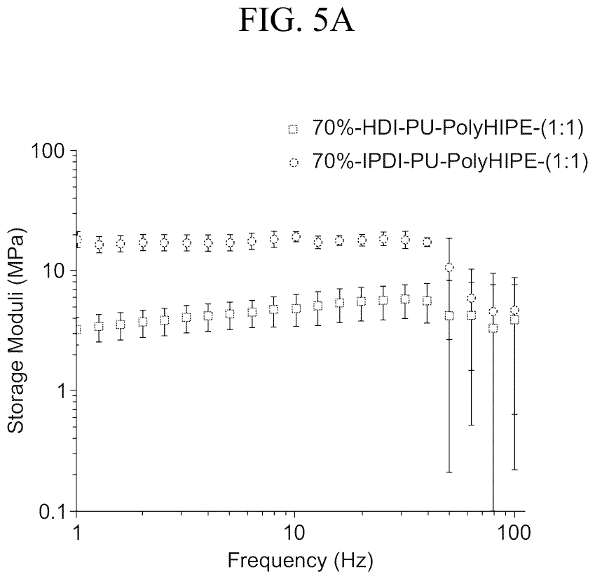

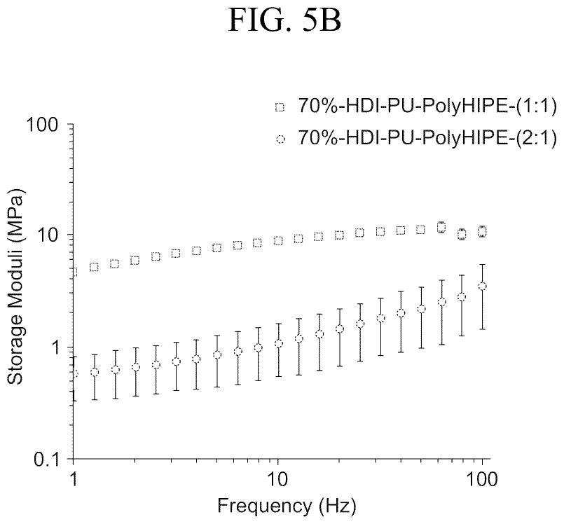

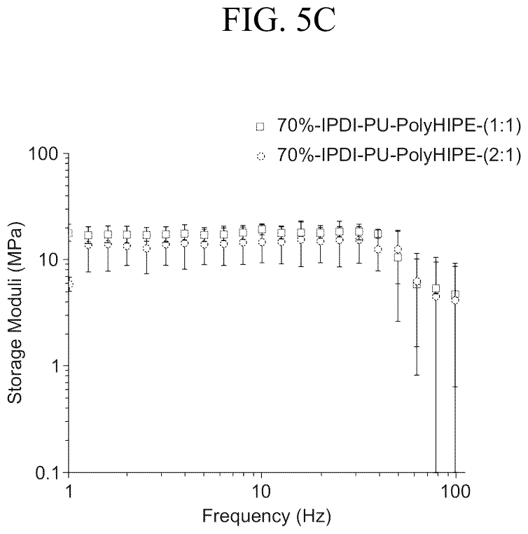

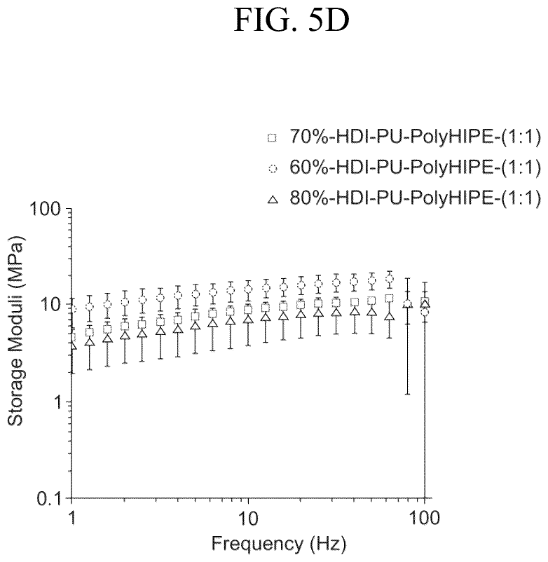

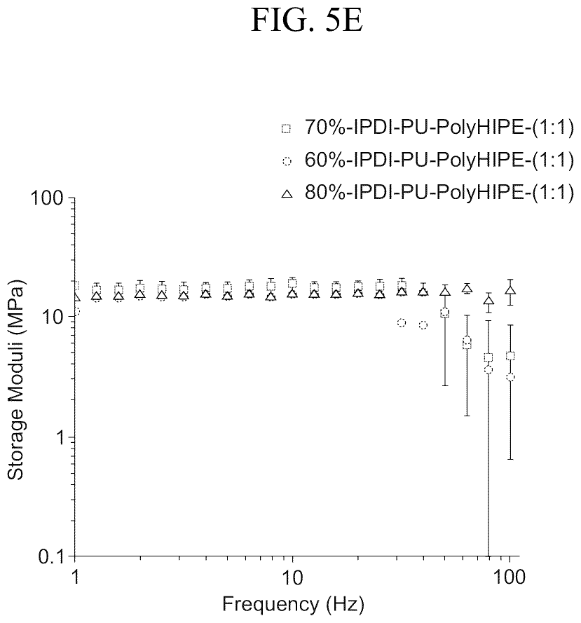

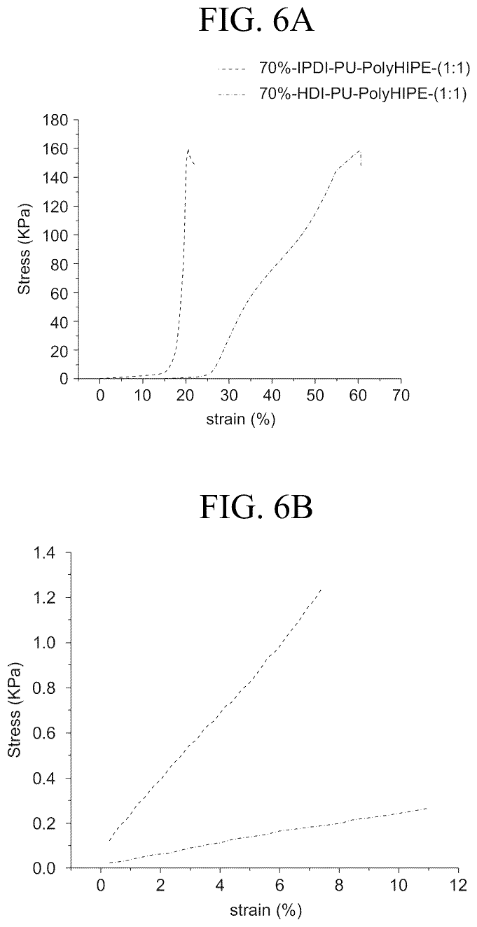

The polyHIPEs derived from IPDI-and TDI-PUs were brittle and inelastic compared to the HDI-PU polyHIPE, as shown in FIGS. 4A-4C. The PU polyHIPEs were characterized using DMA and compression tests to quantify their mechanical properties (FIGS. 5A-5E, FIGS. 6A and 6B). The tunability of mechanical properties of PU-based polyHIPEs was investigated by changing the emulsion composition, including the thiol-to-ene ratio and the volume fraction of the dispersed phase. The compositions of each formulation are given in Table 5. Unfortunately, it was not possible to characterize the TDI-based PU polyHIPEs due to their brittleness and low shear resistance.

The compositions for each polyHIPE used in FIGS. 5A-5E are provided in Table 5.

TABLE 5
Composition of PU polyHIPEs

| | Thio/ene | Volume fraction of |
|---|---|---|
| HIPE | ratio | dispersed phase |
| 70%-HDI-PU-PolyHIPE-(1:1) | 1:1 | 70% |
| 70%-HDI-PU-PolyHIPE-(2:1) | 2:1 | 70% |
| 60%-HDI-PU-PolyHIPE-(1:1) | 1:1 | 60% |
| 80%-HDI-PU-PolyHIPE-(1:1) | 1:1 | 80% |
| 70%-IPDI-PU-PolyHIPE-(1:1) | 1:1 | 70% |
| 70%-IPDI-PU-PolyHIPE-(2:1) | 2:1 | 70% |
| 60%-IPDI-PU-PolyHIPE-(1:1) | 1:1 | 60% |
| 80%-IPDI-PU-PolyHIPE-(1:1) | 1:1 | 80% |

The synthesized PU polyHIPEs were named as x-PU-PolyHIPE-y with x being the dispersed phase volume fraction and y being the thiol to ene ratio. For example, a HDI based PU polyHIPE made with 75% dispersed phase and 1:1 thiol to ene ratio is named 75%-HDI-PU-PolyHIPE-(1:1). The storage modulus (G′) data obtained using DMA for a 70%-HDI-PU-PolyHIPE-(1:1) and 70%-IPDI-PU-PolyHIPE-(1:1) are shown in FIG. 5A. The 70%-HDI-PU-PolyHIPE-(1:1) possessed a G′ value of ˜5 MPa compared to 70%-IPDI-PU-PolyHIPE-(1:1), which possessed a much higher G′ of around 18 MPa, indicating the softer, more flexible nature of the HDI-based PU polyHIPE compared to the IPDI-based PU polyHIPE. Next, the DMA results for the PU polyHIPEs prepared with varying thiol-ene crosslinking ratios were compared. When increasing the thiol to ene ratio from of HDI-based PU polyHIPEs 1:1 to 2:1 the G′ value decreases from ˜5 MPa to ˜1 MPa (FIG. 5B). Without being bound by theory, this result may be because the excess small molecule thiol crosslinkers can act as plasticizers in the PU network. Alternatively, the excess thiols may lead to more thiols connecting two or three PU strands together in the network rather than four, leading to looser junction points and more flexibility in the polyHIPE. Interestingly, no significant difference was observed in the storage moduli for IPDI-based PU polyHIPEs upon increasing the thiol to ene ratio used in their synthesis. This result may be explained by the inherent stiffness of these networks regardless of the crosslinker content (FIG. 5C). PU polyHIPEs prepared with changing volume fraction of the dispersed phase are presented in FIG. 5D and 5E. The 60%-HDI-PU-PolyHIPE-(1:1) showed a slightly higher G′ of 10 MPa compared to the 70%-HDI-PU-PolyHIPE-(1:1) due to a decrease in porosity. A similar result was observed in our previous work where the G′ of PDMS based polyHIPE decreased with the increase of dispersed phase volume fraction. Interestingly, the 80%-HDI-PU-PolyHIPE-(1:1) did not show a further decrease in storage modulus with respect to 70%-HDI-PU-PolyHIPE-(1:1), but did show more variability in the measured values of G′. Again, no differences in G′ were observed for the IPDI-based PU polyHIPEs with different volume fractions of the dispersed phase in the emulsion templates due to the stiffness of the polyurethanes.

The compression stress-strain curves of the 70%-HDI-PU-PolyHIPE-(1:1) and 70%-IPDI-PU-PolyHIPE-(1:1) are shown in FIGS. 6a and 6B.

The stress-strain curves (FIG. 6A) exhibited the three distinct regions found in typical stress-strain curves for polymer foams; a linear elastic region at low strains where the pores become compressed, a stress plateau region due to rapid deformation in polymer structure due to pore collapse, and a densification region where all the pores are collapsed and behave like a nonporous polymer. The Young's modulus of the polyHIPEs were obtained from the linear slope of the initial elastic region of the curve from 0 to 10% strain (FIG. 6B). The Young's modulus and strain at machine limitation stress of PU polyHIPEs are shown in Table 6.

TABLE 6
Young's modulus and strain (maximum) of PU
polyHIPEs prepared using 70% dispersed phase

| polyHIPE | Young's modulus (KPa) | Strain (Maximum) |
|---|---|---|
| HDI-PU polyHIPE | 0.44 | 62% |
| IPDI-PU polyHIPE | 11 | 24% |

The 70%-HDI-PU-PolyHIPE-(1:1) possessed a lower young modulus of ˜0.44 KPa and a higher strain of ˜62% at the limit of the instrument stress compared to the 70%-IPDI-PU-PolyHIPE-(1:1), which exhibited Young's modulus of ˜11 KPa with a strain of 24% at the limit of the instrument stress, reflecting the difference in polymer structure where HDI-based PUs are more flexible. Collectively, the mechanical testing results and SEM images of these PU polyHIPEs demonstrate that the mechanical properties of PU polyHIPEs can be varied through the type of diisocyanate used to prepare the PU prepolymers, while maintaining the total porosity and porous morphology of the material. Therefore, these PU polyHIPE foams can be used for a wide range of applications in industrial and biomedical fields by manipulating their mechanical and structural properties through the appropriate use of the polymer chemistry and the formulation of the emulsion template.

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

What is claimed is:

1. A method of making a polyurethane polymerized high internal phase emulsion (polyHIPE) comprising:
a. preparing a polyurethane prepolymer,
b. crosslinking the polyurethane prepolymer using a thiol-alkene Michael addition, producing a polyurethane polymerized high internal phase emulsion.

2. The method of claim 1 wherein the polyurethane prepolymer is prepared by reacting diisocyanate and trimethylolpropaneallylether (TMPAE).

3. The method of claim 2 wherein the diisocyanate is hexamethylene diisocyanate.

4. The method of claim 2 wherein the diisocyanate is isophorone diisocyanate.

5. The method of claim 2 wherein the diisocyanate is toluene diisocyanate.

6. The method of claim 1 wherein the thiol-alkene Michael addition comprises mixing the polyurethane prepolymer with pentaerithritol tetrakis-3-mercaptopropionate (PETMP).

7. The method of claim 1 wherein the polyurethane prepolymer is crosslinked using water as a dispersed phase.

8. The method of claim 1 wherein the polyurethane prepolymer is crosslinked in less than 10 minutes.

9. A polyurethane polyHIPE produced using the method of claim 1.

10. The polyurethane polyHIPE of claim 9 wherein the polyHIPE has pores of a similar size and the majority of the pores are interconnected.

11. The polyurethane polyHIPE of claim 9 wherein the polyHIPE has an average pore size from 5 to 10 μm.

12. The polyurethane polyHIPE of claim 9 wherein the polyHIPE has an average density from 0.21 to 0.33 g/ml.

13. A method of making a polyurethane polymerized high internal phase emulsion (polyHIPE) comprising:
a. preparing a vinyl-functionalized polyurethane prepolymer,
b. crosslinking the polyurethane prepolymer using a photoinitiated thiol-alkene reaction, producing a polyurethane polymerized high internal phase emulsion.

14. The method of claim 13 wherein the polyurethane prepolymer is crosslinked using a water in oil emulsion template.
